(19) United States
(12) Patent Application Publication
(10) Pub. No.: US 2002/0053021 A1
(43) Pub. Date: May 2, 2002

(54) Internet-based secure document signing network

(76) Inventors: Marion R. Rice, Rochelle, TX (US); Bindu R. Rao, Austin, TX (US)

Correspondence Address: Bindu R. Rao, 3414 Rosefinch Trail, Austin, TX, 78746, US

(21) Appl. No.: 09/824,624

(22) Filed: Apr. 2, 2001

Related U.S. Application Data
(60) Provisional application No. 60/235,228, filed on Sep. 25, 2000.
(60) Provisional application No. 60/235,128, filed on Sep. 25, 2000.

(51) Int. Cl. H04L 9/00

(52) U.S. Cl. 713/155; 713/176

(57) ABSTRACT

An Internet-based secure document signing network is used to authenticate users and help them sign documents employing a signing party certification environment where a certification party, such as a notary, verifies the identity of signing users and lets them sign documents. When a user needs to sign a document, the user obtains the document ID and a password from the creator of the document and then gives it to the certification party to retrieve the document so as to be able to sign the document in the presence of the certification party. The certification party has digital certificates on his computer and an account with the document server that provides access to documents created by the creator. In addition, the Internet-based secure document signing network dispenses digital signatures to end users, who then use the digital certificates for secure access to documents and other information provided by secure servers. The Internet-based secure document signing network employs the services of a digital certificate dispensing unit to dispense certificates.

### CROSS REFERENCE TO RELATED APPLICATIONS

This application is based on U.S. Provisional Application Ser. Nos. 60/235,228 and 60/235,128, both filed Sep. 28, 2000. Such Provisional Applications are hereby incorporated herein by reference in their entirety.

### BACKGROUND

1. Technical Field

The present invention relates generally to the signing of documents, and more specifically to the signing of documents over the Internet employing electronic image signatures and digital signatures.

2. Related Art

Documents in general, and financial, medical and legal documents in particular, are signed by one or more individuals. The signatures are sometimes necessary for legal purposes, and the dates when these signatures were acquired are also typically important. For example, a physician's signature is essential for processing patient care related information in hospitals and in home health care agencies, and are often required before disbursement of funds.

With the rapid acceptance of the Internet by businesses, much of the work that businesses conduct is likely to move to the Internet. The Internet makes it easy to transfer information, interact remotely and to exchange files. However, the need to sign and approve documents as part of normal business transactions has not gone away. Signing documents constitutes a part of the workflow in most business transactions, but the facility to support signing of documents over the Internet is virtually non-existent.

### BRIEF DESCRIPTION OF THE DIAGRAMS

The numerous objects and advantages of the present invention may be better understood by those skilled in the art by reference to the accompanying figures in which:

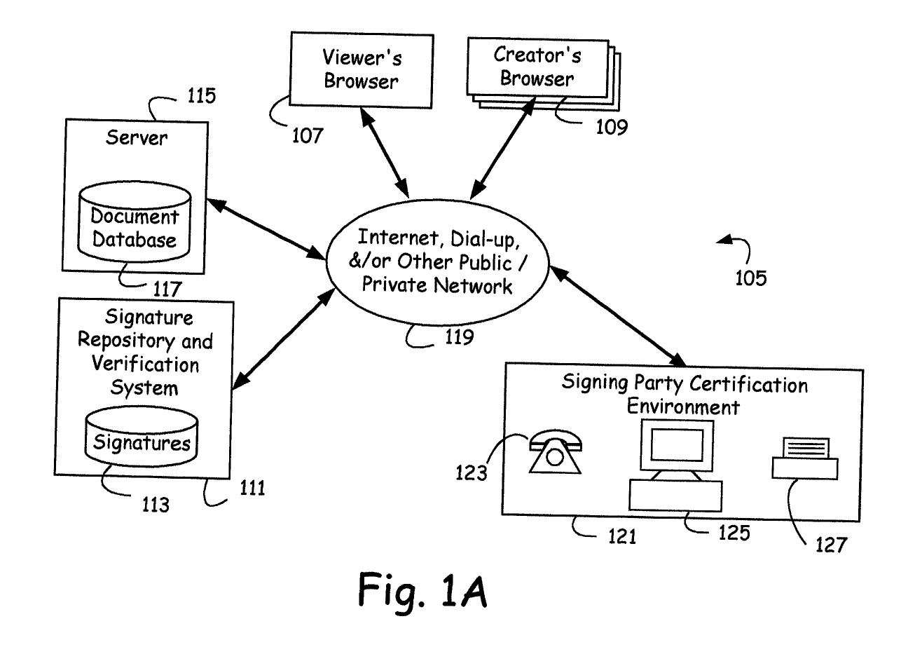

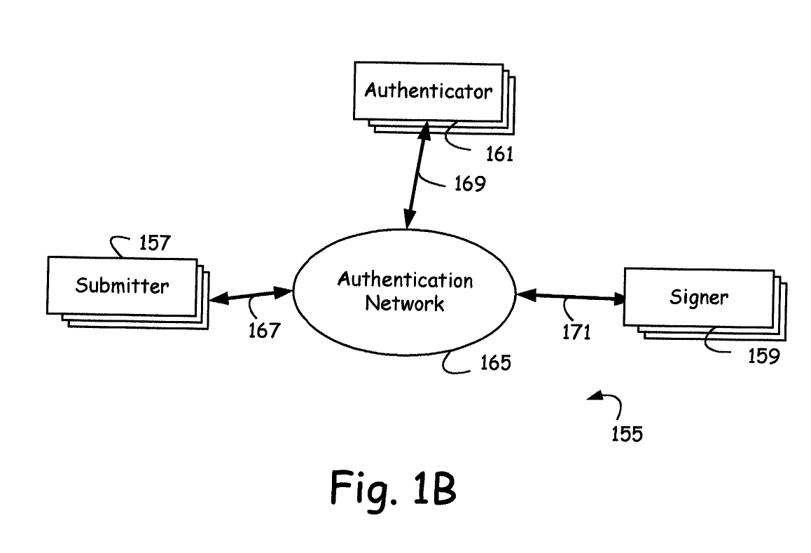

FIG. 1A is a perspective diagram of an Internet-based secure document signing network that provides mechanisms for the specification of placement information for signatures and dates on documents and the retrieval of such documents for viewing and signing purposes by authorized individuals;

FIG. 1B is a perspective diagram of an authentication infrastructure, comprising an authentication network, that provides mechanisms for the submission of one or more documents by a submitter that need to be signed; for the signing of documents by a signer; and, for the authentication of a signer by an authenticator;

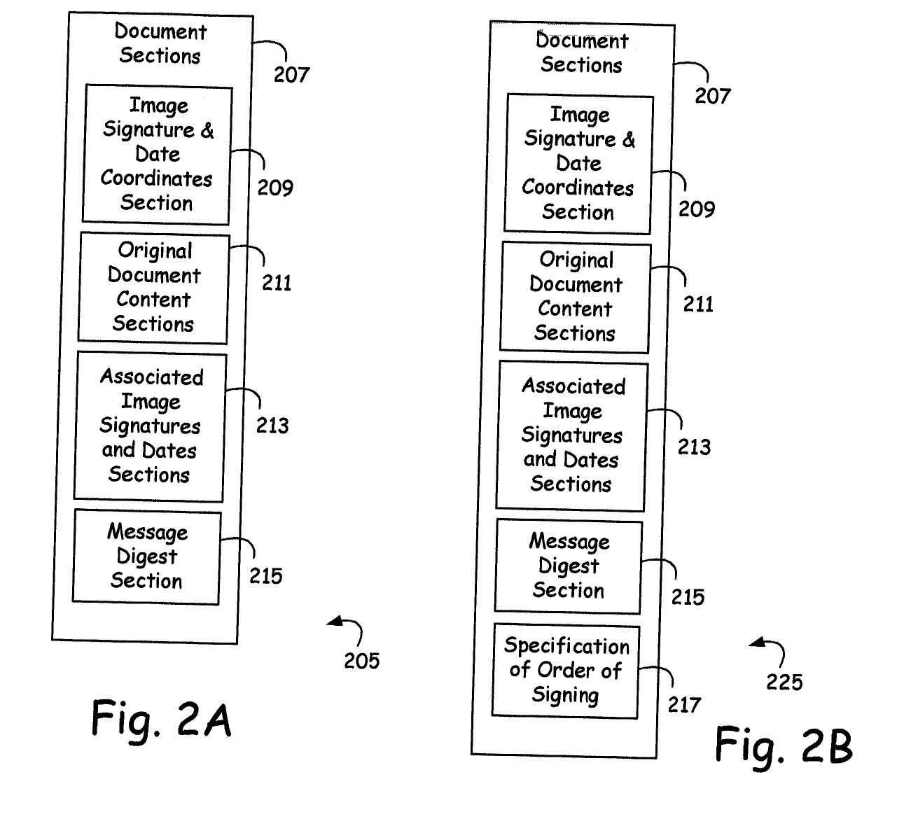

FIG. 2A is a block diagram of an exemplary document that, while being made secure employing a user's public and private key combination, also has embedded electronic image signatures and associated dates along with information regarding the placement of such electronic image signatures and dates;

FIG. 2B is an exemplary document that comprises, in addition to the sections described for the document in FIG. 2A, a specification of the order of signing section that provides information on the order in which one or more signers are expected to sign the document;

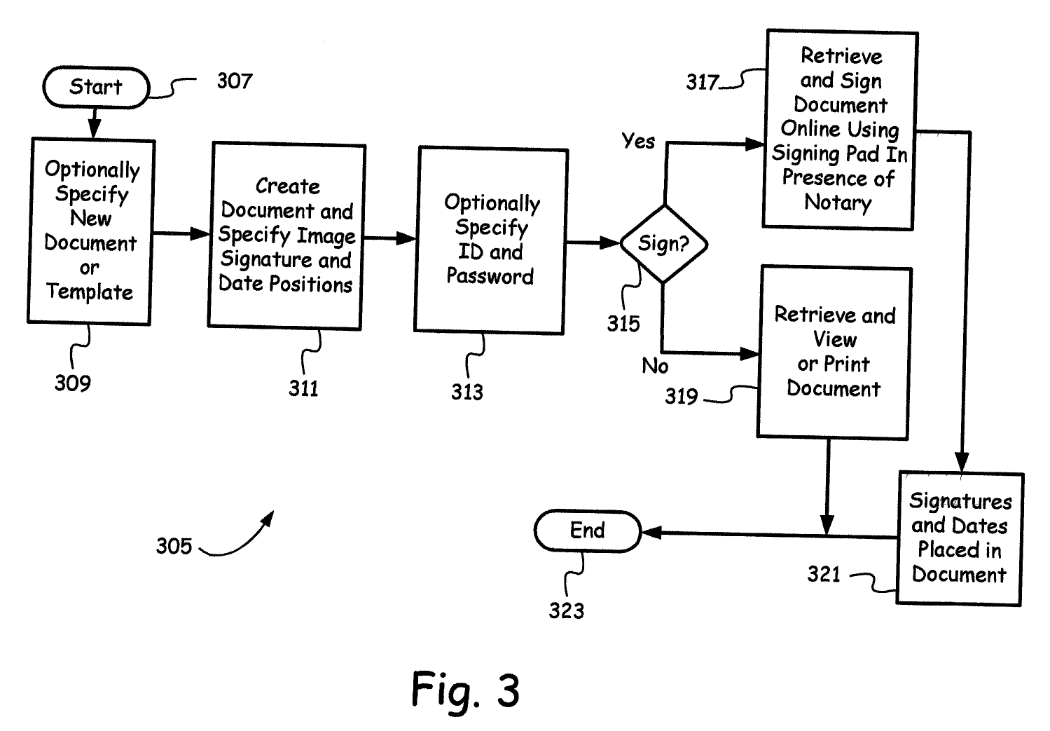

FIG. 3 is a schematic flow diagram depicting the process of specifying signature and date placement information for a document, subsequently retrieving the document for signing purposes using a document ID and password and capturing a signer's signature using a signing pad to associate the signature with the document;

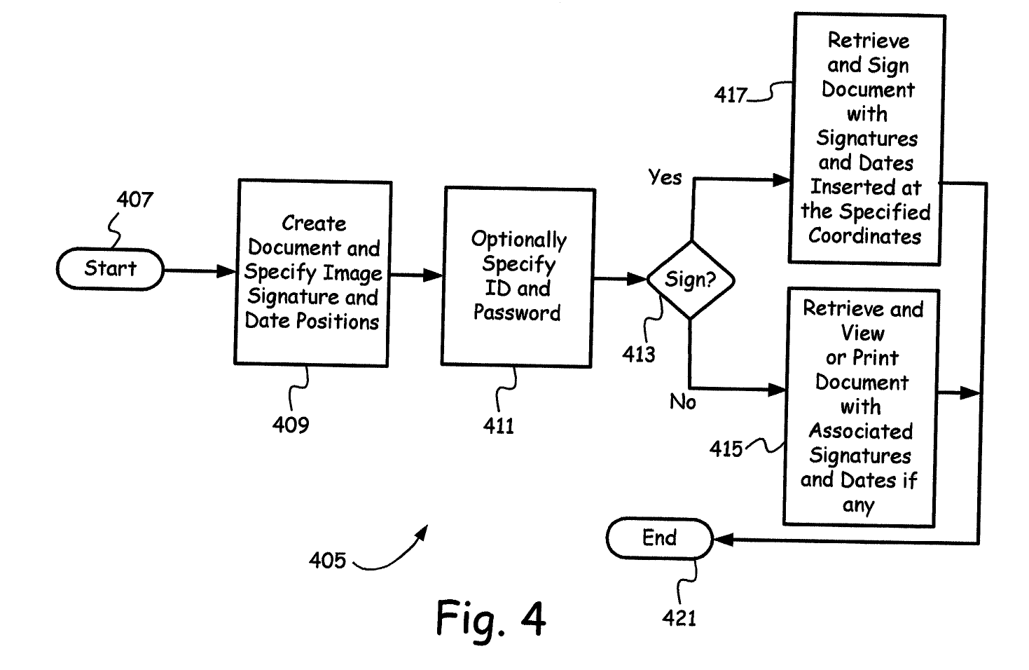

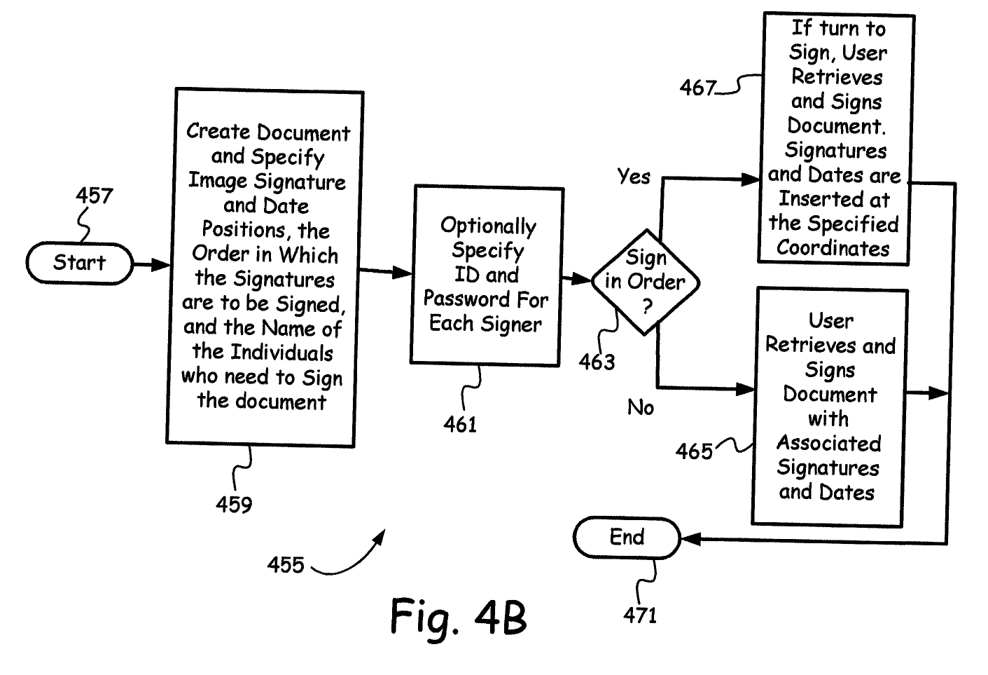

FIG. 4A is a schematic block diagram describing the process of specifying signature and date placement information, employing such signature and date placement information to place signatures and dates when the document is subsequently signed and displaying the document along with the signed signatures and associated dates for viewing or printing purposes. At a block 407, the processing starts;

FIG. 4B is a schematic block diagram describing the process of specifying signature and date placement information and with the order in which specific signers may sign the document;

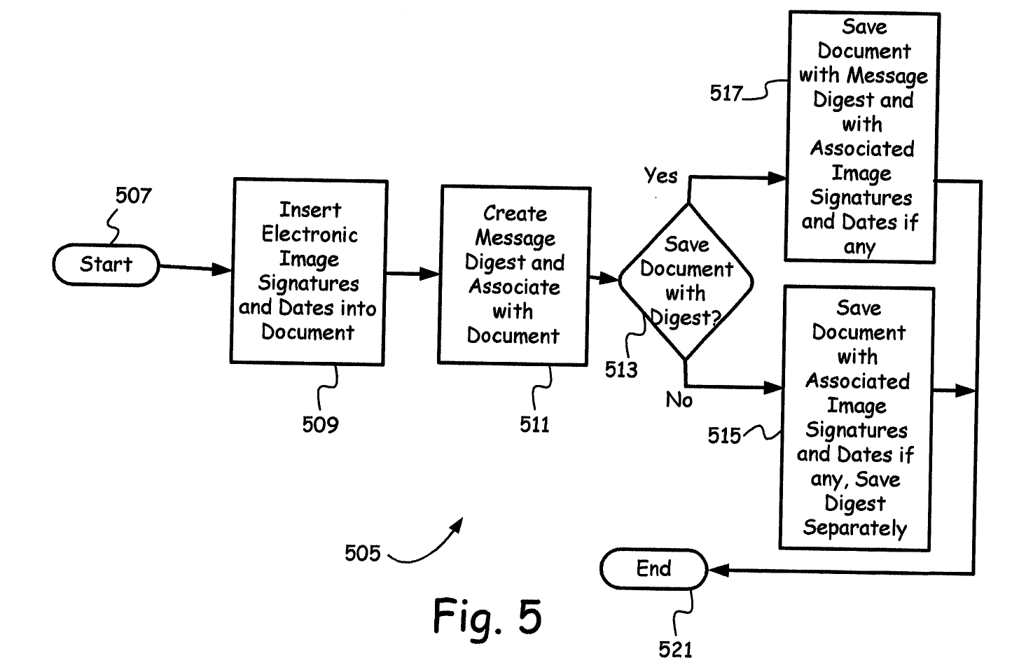

FIG. 5 is a schematic block diagram showing the processing associated with the signing of documents using electronic image signatures and digital signatures;

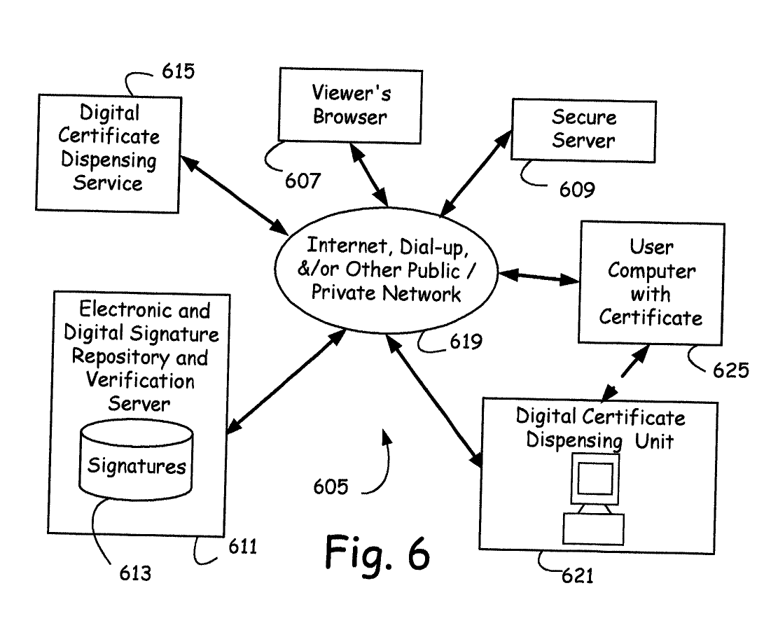

FIG. 6 is a schematic block diagram showing the feature of dispensing digital certificates to users via the signing network, where the signing network is employed as a digital certificate dispensing network; and

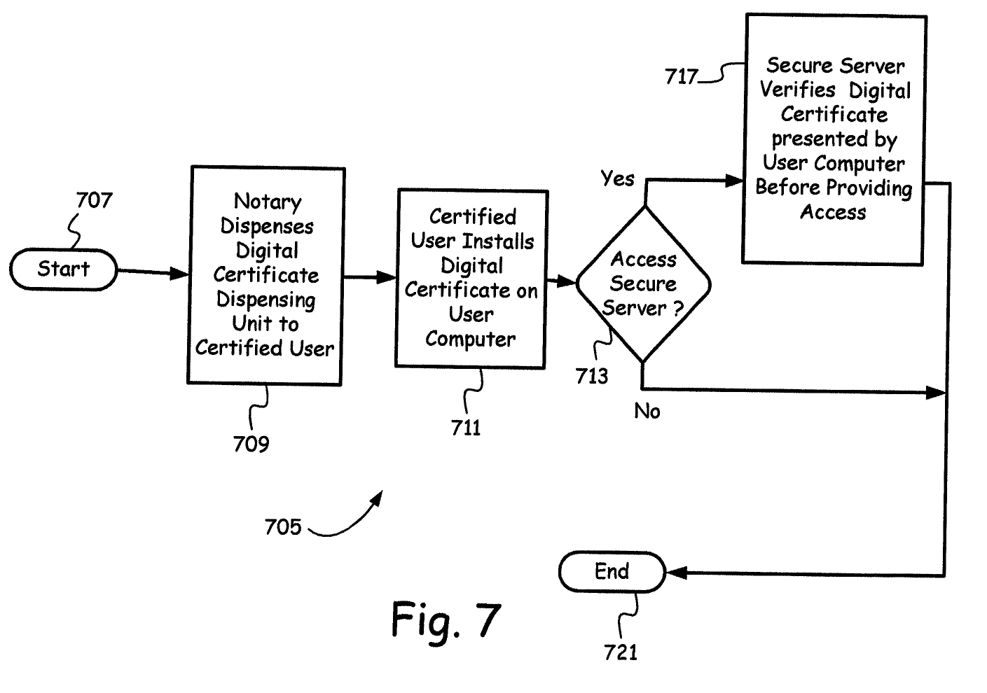

FIG. 7 describes an exemplary work flow of the signing network as a digital certificate dispensing network.

### SUMMARY OF THE INVENTION

An authentication infrastructure comprises a document, a submitter client computer running a submitter function that facilitates submission of the document by a submitter, an authenticator client computer running an authenticator function that facilitates the selective authentication of a signer by an authenticator after the presentation of authentication related information by the signer. The authentication infrastructure facilitates submission of the document by the submitter via the submitter function, the subsequent signer authentication by the authenticator employing the authenticator function and the signing of the document by the signer after signer authentication.

In one embodiment, the authentication infrastructure of claim further comprises a signer computer running a signer function that facilitates viewing of the document by the signer. The authentication infrastructure facilitates document submission by the submitter employing the submitter function, document viewing by the signer employing the signer function and signer authentication by the authenticator employing the authenticator function.

Additionally, authenticator function of the authentication infrastructure selectively requires the authenticator to provide authentication information before facilitating the selective authentication of the signer. Similarly, the authentication infrastructure requires the signer to authenticate himself to the authenticator by presenting authentication related information to the authenticator before allowing the signer to sign documents in the presence of the authenticator.

In another embodiment, the authentication infrastructure further comprises a document id for the document and a password associated with the document id. In this setup, the authentication infrastructure provides the signer access to the document when the signer presents the document id and its associated password.

In another embodiment, the authenticator function of the authentication infrastructure also comprises a signing pad that facilitates capturing a signature from the signer. In this setup, the authentication infrastructure provides the authenticator access, via the authenticator function, to the document after the authenticator submits the document id and its associated password communicated by the signer. In addition, the authenticator function facilitates the signing of the document by the signer by capturing the signature of the signer via the signing pad and associating it with the document to be signed.

In a related embodiment, the authentication infrastructure of claim 5 further comprises an order of signing by a plurality of signers specified by the submitter. The submitter function facilitates the specification of the order of signing by the plurality of signers. The authentication infrastructure is capable of selectively enforcing the order of signing by the plurality of signers. The authentication infrastructure enforces the order of signing by the plurality of signers when the submitter submits a document for signing via the submitter function.

In yet another embodiment, the authentication infrastructure also comprises a fax machine communicatively coupled to the authenticator function. The authenticator function facilitates the signing of the document by the signer by capturing the signature of the signer via the signing pad and associating it with the document to be signed. In addition, the authenticator function employs the fax machine to selectively transfer the signed document after it has been signed.

In an embodiment that provides an extra level of security, the authentication infrastructure comprises a digital certificate installed at the authenticator client computer. The digital certificate is presented by the authenticator function running on the authenticator client computer for client authentication and the digital certificate is employed by the authenticator function for selectively encrypting and decrypting information that are associated with the document during the signing process.

In one embodiment of the authentication infrastructure a signing party certification environment, communicatively coupled to the server, is used to enhance the authenticator function. A server, communicatively coupled to the submitter client computer, running the submitter function and the authenticator client computer running the authenticator function are also employed. The signing party certification environment comprises the authenticator client computer, a telephone used selectively by the signer or the authenticator to talk to the submitter to determine the document id and password associated with the document. It also comprises a fax machine selectively used by the authenticator to fax a document signed by the signer to the server or to the submitter.

In one embodiment, public key encryption is employed for security. A public and private key pair is assigned to the submitter. The document comprises sections for embedding electronic image signatures and associated dates along with sections for information regarding the placement of such electronic image signatures and dates. The submitter function makes the document secure employing the submitter's public and private key combination when the document is submitted for signing by the submitter. The authenticator function accesses the document employing the public key of the submitter to enable the signer to sign the document. In addition, the authenticator function populates the sections for embedding electronic image signatures and associated dates with the signer's signature and associated signing date when the signer signs the document in the presence of the authenticator.

In a different embodiment, the authentication infrastructure comprises an authentication network, a submitter client computer, communicatively coupled to the authentication network, that facilitates document submission by a submitter and an authenticator client computer, communicatively coupled to the authentication network, that facilitates the selective authentication of a signer by an authenticator after the presentation of authentication related information by the signer. The authentication network facilitates document submission by the submitter via the submitter client computer, the signer authentication by the authenticator employing the authenticator client computer and the subsequent document signing by the signer after signer authentication employing the authenticator client computer.

The authentication infrastructure may further comprise submitted documents that may be signed or unsigned, a signer client computer, that facilitates viewing of submitted documents, a document repository, managed by the authentication network for storing the submitted documents and subsequently selectively retrieving them for signing. In addition, a status information of submitted documents that may change is also available. The authentication network manages the storage and retrieval of signed and unsigned submitted documents.

Additionally, the signer client computer facilitates the selective viewing of the submitted document, the submitter client computer facilitates the selective viewing the submitted documents and the authentication network facilitates the selective storage and retrieval of the submitted documents.

In a related embodiment, the authentication network facilitates a new document submission by the submitter over the Internet employing the submitter client computer and the subsequent signing of the submitted new document by the signer employing the authentication client computer over the Internet after the signer has been authenticated by the authenticator employing the authentication client computer over the Internet. Again, the new document may be created and submitted employing the submitter client computer for signing by the signer over the Internet via the signer client computer.

In an embodiment that supports specification of locations for signatures and dates that are included in a document, the submitter client computer of the authentication infrastructure comprises an Internet browser-based drag-and-drop rectangular box drawing utility for drawing a rectangular box on the new document. The rectangular box specifies the coordinates of a one of a plurality of information items. The Internet browser-based drag-and-drop rectangular box drawing utility facilitates selective relocation of the rectangular box on the new document that specifies the coordinates of the one of a plurality of information items. In addition, the submitter client computer facilitates the storage of the new document along with the specified coordinates of the one of a plurality of information items in the authentication network on submission of the new document by the submitter.

In addition, the authenticator client facilitates the population of the one of a plurality of information items associated with the document at the specified coordinates when the signer signs the document with the help of the authenticator via the authenticator client computer. The authentication network also facilitates the viewing of the signed new document by the submitter via the submitter client computer.

In a different Internet-based embodiment of the present invention, sn Internet-based authentication infrastructure comprises a paper document, a plurality of information items and a submitter client computer with a scanner for scanning the paper document. The submitter client computer facilitates the creation of a new document by the scanning of the paper document on the scanner. The submitter client computer also facilitates the selective specification of placement information for the plurality of information items within the new document.

In addition, the Internet-based authentication infrastructure may further comprise a document repository. The submitter client computer saves the new document along with the specification of placement information for the plurality of information items in the new document, at the document repository, as a submitted document.

In a related embodiment, the Internet-based authentication infrastructure further comprises an authenticator client computer, communicatively coupled to the document repository, that facilitates the authentication of a signer by an authenticator having access to the authentication infrastructure. The authenticator client computer facilitates the retrieval of the submitted document from the document repository. The authenticator client computer facilitates the selective population of the plurality of information items in the submitted document by the signer and by the authenticator after authentication of the signer by the authenticator. In addition, the authenticator client computer facilitates the selective storage of the populated submitted document in the document repository.

Other aspects, advantages and novel features of the present invention will become apparent from the following detailed description of the invention when considered in conjunction with the accompanying drawings.

### DETAILED DESCRIPTION OF THE DIAGRAMS

FIG. 1A is a perspective diagram of an Internet-based secure document signing network 105 that provides mechanisms for the specification of placement information for signatures and dates on documents and the retrieval of such documents for viewing and signing purposes by authorized individuals. The Internet-based secure document signing network 105 comprises a creator's browser 109 used by a document creator to specify placement information, such as coordinates and page numbers, for the placement of signatures, dates, etc. on documents, a signing party certification environment 121 used by one or more signers to view and sign documents in the presence of a certification party, such as a notary, and optionally, a viewer's browser 107 used by a viewer to view the signed document. In addition, a signature repository and verification system 111 is used to capture, save or retrieve electronic image signatures, digital signatures, and digital certificate information, and a server 115 is used to save and retrieve documents from a document database 1 17.

The signature repository and verification system 111 comprises a signature database that is used to store and retrieve electronic image signatures, digital certificates, digital signatures, etc. Using the signing party certification environment 121, the certification party accesses documents that are to be signed, from the server 115, over Internet, Dial-up, &/or Other Public/Private Network 119. The server 115 provides access to the saved documents only after subjecting the certification party to client authentication based on a digital certificate presented by the computer 125 available at the signing party certification environment 121, and based on a login name and password previously established by the certification party with the server 115. The digital certificate presented by the computer 125 to the server 115 is used for dual purposes—for client authentication purposes as well as for selectively encrypting and/or decrypting information that are associated with the document during the signing process.

The signing party certification environment typically consists of a computer 125 used by the certification party to access documents from the server 115 over the Internet 119, a telephone 123 used selectively by the signing party or the certification party to talk to the creator of the document to determine the document ID and password associated with the document to be signed, and a fax machine 127 selectively used by the certification party to fax a document signed by the singing party to the server 115 or to the creator of the document. The certification party employs the computer 125 to access the server 115 over the Internet 119, such access requiring the certification party to login using a login name and a password. Specific documents are then retrieved, using an Internet browser or a client software, by the certification party from the server 115 by providing document Ids and associated password, such documents when displayed on the Internet browser or client software being capable of being signed by a signing party.

In one embodiment of the present invention, the computer 125 has a signing pad attached to it to facilitate signing of documents via a signing pen. The signing pad is typically used by the certification party to gather signatures from the signing parties as part of the process of signing documents. Such signatures gathered from a signing pad attached to the computer 125 are automatically associated with the current document being viewed via the Internet browser or client software by the signing party and the certification party on the computer 125. Although a signing pad is envisioned as a mechanism for gathering signatures, other input devices may be used for the same purpose.

The signature or date placement information is specified by a user using the creator's browser 109 by means of a document viewing software that facilitates the specification of coordinates for signatures and dates on top of an existing document. Such signature or date placement information is subsequently associated with the document itself and stored in a document database 117 accessible via the server 115. In one embodiment, the server 115 is a web server that makes the document database 117 accessible via the Internet, dial-up &/or other public/private network 119 to users using the viewer's browser 107, the creator's browser 109 or the signing party certification environment 121. The document viewing software is executed on the creator's browser 109 in order to specify one or more signature and date placement information. In one embodiment, all such signature and date placement information is typically stored along with the document itself in the document database 117. In another embodiment, all such signature and date placement information is associated with the document but stored external to the document itself at the document database 117.

The document database 117 is used to store and retrieve documents, document templates, etc. Specifically, it is used to store documents with their contents, associated signature and date placement information, the signatures and dates themselves, and document security related information such as message digests, etc. More specifically, the signature or date placement information includes coordinates, corresponding page information, such as page numbers, etc.

In one embodiment, the creator's browser 109, the signing party certification environment 121 and the viewer's browser 107 is the same machine. In another related embodiment, the server 115 and the signature repository and verification system 111 are also incorporated into this same machine. In another embodiment, the server 115 and the signature repository and verification system are combined into one unit accessible over the Internet 119.

Typically, when a user needs to sign a document, the user obtains the document ID and a password from the creator of the document and then gives it to the certification party to retrieve a document so as to be able to sign the document in the presence of the certification party. The certification party has digital certificates and an account with the server 115 that provides access to documents created by the creator.

FIG. 1B is a perspective diagram of an authentication infrastructure 155, comprising an authentication network 165 that provides mechanisms for the submission of one or more documents, by a submitter using a submitter client computer, that need to be signed; for the signing of documents by a signer; and, for the authentication of a signer by an authenticator.

A creator or submitter employing the submitter client computer 157 creates and submits a document requiring signatures of a signer using signer client computer 159, the authenticator using the authenticator client computer 161 capable of conducting the authentication of signer 159 via the authentication network 165.

If the document creator or submitter using the signer client computer 157 is also required to sign a document, the document creator or submitter can also participate in the signing process supported by the authentication network 165. Thus, the authentication of a submitter of a document is possible along with authentication of a signer whose signatures are required on the document.

In general, all signers of a document, employing the signer client computer 159, will receive selective notification from the authentication network 165 about the need to sign documents. Again, in general, for each document that needs to be signed, the associated signer, employing the signer client computer 159, receives an indication or notification via the authentication network. The specification of who is to sign a document or who receives a notification is specified by the submitter or by a workflow control specification that is part of the authentication network 165. Notification is also provided if a document involves a plurality of signers.

FIG. 2A is a block diagram of an exemplary document 205 that, while being made secure employing a user's public and private key combination, also has embedded electronic image signatures and associated dates along with information regarding the placement of such electronic image signatures and dates. Specifically, the document 205 comprises an original document content sections 211, an image signature and date coordinates section 209, an associated image signatures and dates sections 213, and a message digest section 215.

The original document content sections 211 comprises one or more sections of a document originally created using an editor such as Microsoft Word, or a scanned image of a paper document. In one embodiment, it is a string of bytes in a tiff image format, representing the scanned image of a paper document.

When a document is initially created by an user, only the original document content sections 211 is available. Later, using a Document Viewer tool, the user specifies locations for one or more signatures and dates, which are then saved in the image signature and date coordinates section 209. When another user, such as a user who signs the document using the signer's browser 121, signs the document, the electronic image signature of the user is retrieved from the signature repository and verification system 111 and inserted into the associated image signatures and dates sections 213, along with corresponding dates. In addition, a message digest 215 is computed by the signer's browser or the server 115 and inserted into the message digest section 215 of the document 207.

In one embodiment, the message digest is computed using the by the signer's browser 121 using the original document content sections 211, the image signature and date coordinates section 209 and the associated image signatures and dates sections 213 and inserted into the document. In another embodiment, only a subset of the available sections of a document are employed to generate the message digest.

FIG. 2B is an exemplary document 225 that comprises, in addition to the sections described for the document 205 in FIG. 2A, a specification of order of signing section 217 that provides information on the order in which one or more signers are expected to sign the document. The creator of the document is expected to optionally specify the order in which the signers should sign the document, using a document viewer that is executed using the creator's browser 109. Such information is subsequently employed by the server 115 to enforce the order when the document is accessed over the Internet 119 by the certification party via the computer 125.

FIG. 3 is a schematic flow diagram depicting the process of specifying signature and date placement information for a document, subsequently retrieving the document for signing purposes using a document ID and password and capturing a signer's signature using a signing pad to associate the signature with the document. At a block 307, the processing starts and a subsequent block 309, a document creator either specifies a given document as a source or optionally specifies a document template and creates a document.

At a next block 311, the user drags the mouse drawing a box on specific sections of the document thus specifying the location of a signature or a date. The creator's browser 109 or a document viewer software application then keeps track of the coordinates of the box drawn by the user that indicates the location for the placement of a signature or a date. The coordinates for signatures and dates are captured and saved. At a next block 313, the creator of the document optionally specifies a document ID and a password for its retrieval by others.

Later, at a next block 315, when a signer decides to sign the document in the presence of a certification party at a signing party certification environment 121, the document is retrieved by the certification party using the document ID and its associated password at a next block 317, thus enabling the signer to sign the document by signing on a signing pad connected to the computer 125 inn the presence of the notary. Subsequently, at a next block 321, the signature entered by the signer and the current date is selectively inserted into the document or selectively associated with the document. In addition, any logo or identification used to identify the certification party is also selectively included in or associated with the document, before the processing finally ends at a block 323.

If, at the decision block 315, the signer decides to just retrieve a document and view it or print it, then at a next block 319, the document is retrieved by the signer using the document ID and the password, providing the signer an opportunity to view or print the document, before the processing finally ends at a block 323.

FIG. 4A is a schematic block diagram describing the process of specifying signature and date placement information, employing such signature and date placement information to place signatures and dates when the document is subsequently signed and displaying the document along with the signed signatures and associated dates for viewing or printing purposes. At a block 407, the processing starts. At a next block 409, the user opens a document using a document viewer, the document viewer being accessible over the Internet via the creator's browser or accessible as an independent application. Then, the user, using a mouse, drags a rectangular box on specific locations of the screen where a signature needs to be placed, and the document viewer software records the corresponding placement location, usually in X and Y coordinates. Similarly, the user may choose to specify placement information for a date. One or more Signatures and/or dates may be specified on each page.

In one embodiment, the user also specifies the order in which the signature and dates are to be entered into the documents, thus specifying a workflow for the document. In another embodiment, the user also specifies the identification of actual users who may sign at designated places in the document, in the specified order. In yet another embodiment, the user also specifies the roles of users who are allowed to sign in designated locations in the document.

Then the user can selectively replace the locations of the signatures by redrawing them or by adjusting the coordinates. Subsequently, the document viewer retrieves coordinates associated with each signature and date box specified by the user and saves them, along with the document. The document thus becomes a template that may be reused.

At a next block 411, the user optionally specifies a document ID and password for security, so that only those individuals to whom the document ID and the password is known may be able to view or sign the document. In one embodiment, the user specifies more than one pair of user specifies only one pair of document ID and password set for all the viewers and signers and certification parties who might access the document. In another embodiment, the document ID and password set for the document, one document ID and password set for each of the viewers and signers and certification parties who might access the document.

Later, at a decision block 413, if a certification party chooses to access the document for signing purposes, the document is retrieved at a next block 417 and the user is allowed to sign the document and signatures and dates are placed at all the appropriate specified places in the document, along with the logo, insignia, electronic stamp, and/or identification information of the certification party, before processing stops at a next block 421.

If, at the decision block 413, if a certification party or viewer or signer chooses to access the document for viewing purposes, the document is retrieved at a next block 415 and the viewer or signer or certification party is allowed to view or print the document with all associated signatures, insignias, dates, etc., before terminating the processing at the next block 421.

FIG. 4B is a schematic block diagram describing the process of specifying signature and date placement information and with the order in which specific signers may sign the document. At a block 457, the processing starts. At a next block 459, the creator of a document opens a document using a document viewer, the document viewer being accessible over the Internet via the creator's browser or accessible as an independent application. Then, the creator, using a mouse, drags a rectangular box on specific locations of the screen where a signature needs to be placed, and the document viewer software records the corresponding placement location, usually in X and Y coordinates. Similarly, the creator may choose to specify placement information for a date. One or more Signatures and/or dates may be specified on each page. The creator optionally views the list of date placements and signature placements, selectively associates the order in which the list entries are expected to sign the document, and thus manages the list of signers.

The user then specifies the order in which the signature and dates are to be entered into the documents, thus specifying a workflow for the document. The creator also specifies the identification of actual users who may sign at designated places in the document, in the specified order. Then the creator can selectively replace the locations of the signatures by redrawing them or by adjusting the coordinates. Subsequently, the creator, using the document viewer, retrieves coordinates associated with each signature and date box specified by the user and saves them along with the document.

At a next block 461, the user optionally specifies a document ID and password for security, so that only those individuals to whom the document ID and the password is known may be able to view or sign the document. The creator specifies one document ID and password set for each of the viewers and signers and certification parties who might access the document.

Later, at a decision block 463, if a certification party determines that the document needs to be signed in a specific order and chooses to access the document based on the creator specified order for signing purposes, the document is retrieved at a next block 467 and the signer whose turn it is to sign is allowed to sign the document. Immediately and automatically, signatures and dates are placed at all the appropriate specified places in the document, along with the logo, insignia, electronic stamp, and/or identification information of the certification party, before processing stops at a next block 471.

If, at the decision block 413, if a certification party determines that the document need not be signed in a specific order, the document is retrieved at a next block 465 and the signer is allowed to sign the document. Immediately and automatically, signatures and dates are placed at all the appropriate specified places in the document, along with the logo, insignia, electronic stamp, and/or identification information of the certification party, before processing stops at a next block 471.

FIG. 5 is a schematic block diagram showing the processing associated with the signing of documents using electronic image signatures and digital signatures. At a block 507, the process starts, and at a next block 509, the signer's electronic image signatures and the current date is inserted into the document at all the specified coordinates when the signer signs the document. Then, at a next block 511, a message digest is created and associated with the document. In one embodiment, the message digest is created based on the digital certificate of the certification party and the contents of all the sections except the message digest section of the document. In another embodiment, the message digest is created based on the digital certificate of the certification party and the contents of only a subset of the sections of the document. In yet another embodiment, the message digest is computed based on a digital certificate of the signer and the contents of all or a subset of the sections of the document.

Subsequently, at a next decision block 513, if it is determined that the document must be saved along with the message digest, then at a next block 517, the document is saved along with the message digest and with the associated image signatures and dates, if any, before terminating the processing at a end block 521. Otherwise, if, at the block 513, it is determined that the document need not be saved along with the message digest, then at a next block 515, the document is saved along with the associated image signatures and dates, if any, while the message digest is saved separately, although the document maintains an association via a reference with the message digest. Finally the processing terminates at a end block 521.

FIG. 6 is a schematic block diagram showing the feature of dispensing digital certificates to users via the signing network, where the Internet-based secure document signing network is employed as an Internet-based secure digital certificate dispensing network. The Internet-based secure digital certificate dispensing network 605 comprises a digital certificate dispensing service 615 that creates and supplies digital certificates over the internet, that is communicatively coupled to an electronic and digital signature repository and verification server 611; a digital certificate dispensing unit 621; a user computer 625; and an Internet, dial-up, &/or other public/private network 619.

In the Internet-based secure digital certificate dispensing network 605, a certification party such as a notary employs the digital certificate dispensing unit 621 to collect the signature of users, determine their identify, verify their identify by means of user supplied documentation, and finally, to dispense digital certificates issued by the digital certificate dispensing service 615 via the Internet 619.

The user, to view or sign documents from a secure server 609 using a digital certificate acquires a digital certificate from the digital certificate dispensing unit 621. To acquire the certificate, the user has to approach the certification party operating the digital certificate dispensing unit 621, and in the presence of the certification party, such as a notary, provide information that will identify him. A digital certificate is subsequently selectively given to the user by the digital certificate dispensing unit 621 via a diskette or via email.

Once the user acquires and installs a digital certificate from the digital certificate dispensing unit 621, a user can access documents and information from the secure server 609 which enforces client authentication requiring a digital signature issued by or dispensed by digital certificate dispensing unit 621.

The electronic and digital signature repository and verification system 611 comprises a signature database that is used to store and retrieve electronic image signatures, digital certificates, digital signatures, etc. Certificates dispensed by the digital certificate dispensing unit 621 are communicated to the electronic and digital signature repository and verification system 611.

In one embodiment of the present invention, the digital certificate dispensing unit 621 has a signing pad attached to it to facilitate capturing of electronic image signatures via a signing pen. The signing pad is typically used by the certification party to gather signatures from the signing parties as part of the process of dispensing certificates. Such signatures gathered from a signing pad attached digital certificate dispensing unit 621 are automatically associated with the current user. Although a signing pad is envisioned as a mechanism for gathering signatures, other input devices may be used for the same purpose.

FIG. 7 describes an exemplary workflow of the signing network as a digital certificate dispensing network. At a block 707, the processing begins and at a next block 709, a notary dispenses digital certificate using the digital certificate dispensing unit 621 to a user after certifying the identify of the user using documentation supplied by the user. Later, at a next block 711, the certified user installs the digital certificate on the user's computer. Subsequently, at a next block 713, when the certified user decides to access a secure server 609, the secure server tries to enforce client authentication and requests a client authentication certificate from the certified user's computer 625. The secure server verifies the digital certificate presented by the user computer before providing access to the web pages it manages. Finally, processing stops at an end block 721.

If, at the decision block 713, the certified user chooses to access non-secure servers, then the web pages served by the non-secure servers are processed and display as done normally, and processing terminates at the next bock 721.

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and appended diagrams.

We claim:

1. An authentication infrastructure comprising:
a document;
a submitter client computer running a submitter function that facilitates submission of the document by a submitter;
an authenticator client computer running an authenticator function that facilitates the selective authentication of a signer by an authenticator after the presentation of authentication related information by the signer;
the authentication infrastructure facilitating submission of the document by the submitter via the submitter function, the subsequent signer authentication by the authenticator employing the authenticator function and the signing of the document by the signer after signer authentication.

2. The authentication infrastructure of claim 1 further comprising:
a signer computer running a signer function that facilitates viewing of the document by the signer; and
the authentication infrastructure facilitating document submission by the submitter employing the submitter function, document viewing by the signer employing the signer function and signer authentication by the authenticator employing the authenticator function.

3. The authentication infrastructure of claim 2 wherein the authentication infrastructure further comprising:
the authenticator function selectively requiring the authenticator to provide authentication information before facilitating the selective authentication of the signer; and
the authentication infrastructure requiring the signer to authenticate himself to the authenticator by presenting authentication related information to the authenticator before allowing the signer to sign documents in the presence of the Authenticator.

4. The authentication infrastructure of claim 1 further comprising:
a document id for the document;
a password associated with the document id; and
the authentication infrastructure providing the signer access to the document when the signer presents the document id and its associated password.

5. The authentication infrastructure of claim 4 further comprising:
the authenticator function wherein the authenticator function comprises a signing pad that facilitates capturing a signature from the signer;
the authentication infrastructure providing the authenticator access, via the authenticator function, to the document after the authenticator submits the document id and its associated password communicated by the signer; and
the authenticator function facilitating the signing of the document by the signer by capturing the signature of the signer via the signing pad and associating it with the document to be signed.

6. The authentication infrastructure of claim 5 further comprising:
an order of signing by a plurality of signers specified by the submitter;
the submitter function facilitating the specification of the order of signing by the plurality of signers;
the authentication infrastructure capable of selectively enforcing the order of signing by the plurality of signers;
the authentication infrastructure enforcing the order of signing by the plurality of signers when the submitter submits a document for signing via the submitter function.

7. The authentication infrastructure of claim 4 further comprising:
a fax machine communicatively coupled to the authenticator function;
the authenticator function facilitating the signing of the document by the signer by capturing the signature of the signer via the signing pad and associating it with the document to be signed; and
the authenticator function employing the fax machine to selectively transfer the signed document after it has been signed.

8. The authentication infrastructure of claim 4 further comprising:
a digital certificate installed at the authenticator client computer;
the digital certificate presented by the authenticator function running on the authenticator client computer for client authentication; and
the digital certificate employed by the authenticator function for selectively encrypting and decrypting information that are associated with the document during the signing process.

9. The authentication infrastructure of claim 4 further comprising:
a server communicatively coupled to the submitter client computer running the submitter function and the authenticator client computer running the authenticator function;
a signing party certification environment, communicatively coupled to the server, that enhances the authenticator function;
the signing party certification environment comprising the authenticator client computer used by the authenticator to access the document from the server employing the authenticator function, a telephone used selectively by the signer or the authenticator to talk to the submitter of the document to determine the document id and password associated with the document, and a fax machine selectively used by the authenticator to fax a document signed by the signer to the server or to the submitter.

10. The authentication infrastructure of claim 4 further comprising:
a public and private key pair for the submitter;
the document comprising sections for embedding electronic image signatures and associated dates along with sections for information regarding the placement of such electronic image signatures and dates;
the submitter function making the document secure employing the submitter's public and private key combination when the document is submitted for signing by the submitter;
the authenticator function accessing the document employing the public key of the submitter to enable the signer to sign the document; and
the authenticator function populating the sections for embedding electronic image signatures and associated dates with the signer's signature and associated signing date when the signer signs the document in the presence of the authenticator.

11. An authentication infrastructure comprising:
an authentication network;
a submitter client computer, communicatively coupled to the authentication network, that facilitates document submission by a submitter;
an authenticator client computer, communicatively coupled to the authentication network, that facilitates the selective authentication of a signer by an authenticator after the presentation of authentication related information by the signer; and the authentication network facilitating document submission by the submitter via the submitter client computer, the signer authentication by the authenticator employing the authenticator client computer and the subsequent document signing by the signer after signer authentication employing the authenticator client computer.

12. The authentication infrastructure of claim 11 further comprising:
a submitted documents that may be signed or unsigned;
a signer client computer, that facilitates viewing of submitted documents;
a document repository, managed by the authentication network, for storing the submitted documents and subsequently selectively retrieving them for signing;
a status information of submitted documents that may change; and
the authentication network managing the storage and retrieval of signed and unsigned submitted documents.

13. The authentication infrastructure of claim 12 further comprising:
the signer client computer facilitating the selective viewing of the submitted document;
the submitter client computer facilitating the selective viewing the submitted documents; and
the authentication network facilitating the selective storage and retrieval of the submitted documents.

14. The authentication infrastructure of claim 11 further comprising:
the authentication network facilitating a new document submission by the submitter over the Internet employing the submitter client computer and the subsequent signing of the submitted new document by the signer employing the authentication client computer over the Internet after the signer has been authenticated by the authenticator employing the authentication client computer over the Internet.

15. The authentication infrastructure of claim 14 wherein the new document is created and submitted employing the submitter client computer for signing by the signer over the Internet via the signer client computer.

16. The authentication infrastructure of claim 15 wherein the submitter client computer of the authentication infrastructure further comprising:
an Internet browser-based drag-and-drop rectangular box drawing utility for drawing a rectangular box on the new document that specifies the coordinates of a one of a plurality of information items;
the Internet browser-based drag-and-drop rectangular box drawing utility facilitating selective relocation of the rectangular box on the new document that specifies the coordinates of the one of a plurality of information items; and
the submitter client computer facilitating the storage of the new document along with the specified coordinates of the one of a plurality of information items in the authentication network on submission of the new document by the submitter.

17. The authentication infrastructure of claim 16 further comprising:
the authenticator client facilitating the population of the one of a plurality of information items associated with the document at the specified coordinates when the signer signs the document with the help of the authenticator via the authenticator client computer; and
the authentication network facilitating the viewing of the signed new document by the submitter via the submitter client computer.

18. An Internet-based authentication infrastructure comprising:
a paper document;
a plurality of information items;
a submitter client computer with a scanner for scanning the paper document;
the submitter client computer facilitating the creation of a new document by the scanning of the paper document on the scanner; and
the submitter client computer facilitating the selective specification of placement information for the plurality of information items within the new document.

19. The Internet-based authentication infrastructure of claim 18 further comprising:
a document repository; and
the submitter client computer saving the new document along with the specification of placement information for the plurality of information items in the new document at the document repository as a submitted document.

20 The Internet-based authentication infrastructure of claim 19 further comprising:
an authenticator client computer, communicatively coupled to the document repository, that facilitates authentication of a signer by an authenticator having access to the authentication infrastructure;
the authenticator client computer facilitating the retrieval of the submitted document from the document repository;
the authenticator client computer facilitating the selective population of the plurality of information items in the submitted document by the signer and by the authenticator after authentication of the signer by the authenticator; and
the authenticator client computer facilitating the selective storage of the populated submitted document in the document repository.
